(19) United States
(12) Patent Application Publication
(10) Pub. No.: US 2020/0261794 A1
(43) Pub. Date: Aug. 20, 2020

(54) INTERACTIVE GRAPHIC PROJECTION GAME

(71) Applicants: Jeremy Alexander Patuto, (US); Steel Henessey Jones, (US)

(72) Inventors: Jeremy Alexander Patuto, (US); Steel Henessey Jones, (US)

(21) Appl. No.: 16/280,224

(22) Filed: Feb. 20, 2019

(51) Int. Cl. A63F 13/213; A63F 13/25; A63F 13/837; A63F 13/812; A63F 13/2145

(52) U.S. Cl. CPC A63F 13/213; A63F 13/25; A63F 13/2145; A63F 13/812; A63F 13/837

(57) ABSTRACT

An interactive projection and interface system has a video projector that projects graphic images onto a projection screen or another surface. Participants throw projectiles, for example balls other objects, at the projected screen, attempting to hit target images. Different participants may throw different colored balls. A three-dimensional sensor monitors a three-dimensional space in front of the screen. The three-dimensional sensor identifies objects, their trajectories, their colors, their points of impact on the projection screen and other parameters of the objects. Images on the screen change when they are struck by an object. The system keeps and displays a score for each participant. The three-dimensional sensor may be a video camera utilizing software that determines the distance of a projectile relative to the camera and the project graphic images by measuring the size or width of the projectiles. Where the projectiles are balls, the diameter of the balls observed by the video camera may be used to calculate distance and location of the balls.

### CROSS-REFERENCE TO RELATED APPLICATIONS

This application claims priority to U.S. Provisional Application Ser. No. 62/632,766 filed on Feb. 20, 2018, the contents of which are hereby incorporated in their entirety.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable

### INCORPORATION-BY-REFERENCE OF THE MATERIAL SUBMITTED ON A COMPACT DISC

Not Applicable.

### COPYRIGHT NOTICE

Not Applicable

### BACKGROUND OF THE INVENTION

### Field of the Invention

The present invention relates to a projection system for forming a graphic interface. More particularly, the invention relates to an interactive graphic projection interface system incorporating objects in real time into a large-scale physical activity.

### Description of the Related Art

Event planners, entertainers and marketing specialists have different jobs but all seek to engage their particular audience. One effective method of engaging an audience is to provide relatively simple activities such as games. Games that maximize player participation and have simple easy to learn rules are generally preferred at all types of business events such as trade shows, corporate retreats, conferences and seminars. These same qualities are also desirable when planning more personal events such as weddings, birthday parties, bar mitzvahs and graduation parties. It is often preferable for activities to be simple, easy-to-understand and quickly learned. Guests or participants at events are not likely to engage in games with complicated rules that require time to learn how to play. Activities at group events are also more successful when they directly engage an audience and/or participants. Participant enjoyment correlates with the degree of engagement the participants have. It is also important for various activities to not be too expensive or require substantial preplanning.

For example, one device commonly found at all types of events is a photo booth. The photo booth often includes humorous accessories such as funny hats, fake mustaches, speech bubbles and other items that can be used to create humorous pictures by attendees of an event. A photo booth is extremely easy for an attendee to use, is not expensive, creates lasting momentos and also requires minimal preparation time. However, photo booths have become so common that interest in them wanes.

Video games have long been considered an option to photo booths. However, not everyone is adept at manipulating videogame controllers. The games themselves often require a substantial amount of time to become familiar. Board games have also fallen into disfavor. In problems of conventional systems, and are not intended to be exhaustive. Other problems with the state of the art and corresponding benefits of some of the various non-limiting embodiments may become further apparent upon review of the following detailed description.

In the past several years, there has been increasing demand for video games to incorporate more and more actual reality and less virtual reality. For example, Nintendo® introduced the Wii® that allows an operator to use a specialized controller to mimic real-world activities such as bowling, firing a gun, casting a fishing rod, and other physical activities. These devices project images on a large screen and allow participants to use physical objects to interact with the image as part of the game. This concept is been around since at least the 1980s when Nintendo® produce the popular game Duck Hunt® that allowed participants to shoot a gun at the screen to kill ducks. One drawback to these games was that they were difficult to scale up. Using a larger image generally require the use of a large, complex screen and specially designed objects designed to interact with the screen itself.

In view of the foregoing, it is desirable to provide an interactive game combining a graphic projected image capable of interfacing with operators or participants in the interactive game. It is also desirable to provide a large interactive game that does not require a specialized screen or specialized equipment to interact with the street.

### BRIEF SUMMARY OF THE INVENTION

Disclosed is an interactive graphic projection interface system for use by persons of all ages and levels of computer literacy. The interactive graphic projection system is suitable for events such as Bar Mitzvahs, weddings, small events, large events, holiday parties, corporate events and other gatherings featuring entertainment devices. It is suitable for adults and young children alike.

It is therefore an object of the interactive graphic projection interface system is to provide a major product in the party planning space, adding an alternative to a field where photo booths currently dominate. Bar Mitzvahs, weddings, and other small events often have similar photo booth setups with customized gimmicks such as glasses and funny hats. The interactive graphic projection interface system BTW will provide party planners with a fun, competitive gaming alternative to the photo booth.

The invention turns any wall into an interactive projection gaming experience. Participants have 45 seconds to throw balls at a digitally projected field of play, aiming to hit as many of the objects floating around the screen as possible before time expires. Objects—which can range from animations to captured images—are populated at varying sizes, resulting in more points for contact with the harder-to-hit targets. A leaderboard appears when time runs out, so participants can compete to see their name and face at the top.

In one embodiment, an interactive graphic projection and interface system includes a projection screen, a video projector, a three-dimensional sensor capable of detecting an object within a three-dimensional region in front of the screen, an object's trajectory and the location on the screen where the object impacts the screen, and a control system for controlling the video image projected onto the projection screen by the video projector. The projection screen can be a wall or a free-standing screen mounted on a frame.

If the screen is mounted on a frame, the video projector can be mounted on a support arm extending from the frame. The distance between the projection screen in the video projector may be increased or decreased by adjusting the support arm. The three-dimensional sensor can also be mounted on the frame. A kiosk having a camera and a touchscreen user interface may be used to record and inserts images of participants into a graphic image displayed on the screen.

In another embodiment, An interactive graphic projection game comprises a projector, a video camera, a background image projected onto a surface by the projector, at least one projectile, and a computer in communication with the projector and the video camera, the computer running software that projects at least one target image superimposed over the background image. Software receives video data from the video camera and registers a hit of the at least one projectile on the at least one target image when the at least one projectile has a predetermined size while the at least one projectile is superimposed over the at least one target image. The projectiles may be balls, footballs or other projectiles having a predetermined size. The predetermined diameter of the projectiles is adjusted by the software according to the distance between the video camera and the background image, and the incident angle of the projectiles measured from a direction of shortest distance between the camera and the surface.

The plurality of balls may be of different colors, wherein each of the colors corresponds to a predetermined participant, and wherein the hits registered by the software is are categorized and totaled according for each participant. The surface is a wall or other flat surface such as a floor or ceiling, or a projection screen is mounted on a frame. The video projector can be mounted on a support arm extending from a top of the frame. The distance between the projection screen and the video projector may be increased or decreased by adjusting the support arm. The video camera may also be mounted on the support arm extending from the top of the frame. An image recording device may also be in communication with the control system. The image recording device may be incorporated into a kiosk having a touchscreen interface. The target images may be images of faces of the participants.

It is therefore an object of the present invention to provide an interactive graphic projection that functions as a graphic user interface.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE SEVERAL VIEWS OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an interactive graphic projection and interface system in accordance with the principles of the invention;

FIG. 2 is a perspective view of a kiosk for use with an interactive graphic projection and interface system in accordance with the principles of the invention;

FIG. 3 is a perspective view of an alternative embodiment of an interactive graphic projection and interface system in accordance with the principles of the invention;

FIG. 4 is a side elevation view of an interactive graphic projection and interface system in accordance with the principles of the invention;

FIG. 5 is a front elevation view of a frame for an interactive graphic projection and interface system in accordance with the principles of the invention;

FIG. 6 is a top plan view of a frame for an interactive graphic projection and interface system in accordance with principles of the invention;

FIG. 7 is another environmental perspective view of an alternative embodiment of an interactive graphic projection game in accordance with principles of the invention;

FIG. 8 is a top plan view of the alternative embodiment of an interactive graphic projection game in accordance with principles of the invention.

### DETAILED DESCRIPTION OF THE INVENTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Disclosed is an interactive graphic projection game usable by one or more participants or operators. The interactive graphic projection and interface system as disclosed herein provides an engaging and entertaining experience effective for leisure and entertainment, teambuilding exercises, encouraging group interactions, and moderate physical activity. The system incorporates the images of participants into a dynamic, humorous and entertaining game.

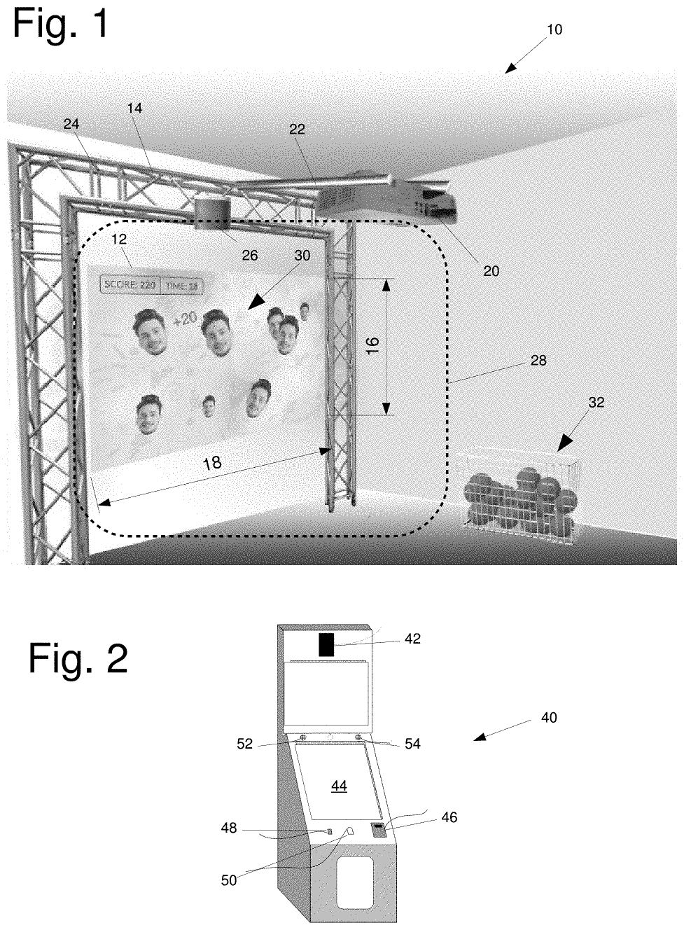

FIG. 1 shows an embodiment of an interactive graphic projection game 10 in accordance with principles of the invention. A projector screen 12 is mounted on a frame 14 and has a height 16 and a width 18. A projector 20 is mounted on one or more support arms 22 which extend from the top 24 of the frame 14. A three-dimensional sensor 26 is also mounted on the frame 14. The three-dimensional sensor 26 is capable of scanning a three-dimensional region 28 in front of the screen 12, including the volume directly in front of the projector screen. Generally, the three-dimensional region 28 may have the same height 16 and width 18 of the screen. The depth 28, i.e. the distance from the projector screen 12 that the three-dimensional region 28 scanned by the three-dimensional sensor 26 extends, may be fixed or may be adjustable.

In use, the projector projects an image 30 onto the projection screen 12. The image 30 may be static, i.e. a still image, or dynamic, i.e. a video image that changes over time. One or more participants of the interactive graphic projection game 10 will interact with the displayed graphics by throwing objects at the projection screen 12 attempting to “hit” one or more images displayed in the graphic image 30. In this embodiment, the objects are basketballs 32. The three-dimensional sensor 22 will detect one or more parameters of these objects, such as for example an object's location in real time, its size, its trajectory, the location on the projection screen 12 where the object impacts the projection screen.

The projector 20 is any projector suitable for projecting a large image onto a wall or projector screen. The three-dimensional sensor 22 can be a camera or other electromagnetic sensor. The sensor 22 is preferably capable of depth tracking. An object in the graphic image on the projector screen is detected by being “hit” only when a ball touches the screen. If a ball is a foot away from the screen, the object in the graphic image will not be hit. The sensor 22 also preferably is capable of distinguishing different colors so that balls or other projectiles of different colors may be distinguished from each other. This allows different colored balls to represent different participants or teams of participants. Preferably, the sensor 22 also detects other non-projectile objects within the three-dimensional area 28 being monitored. If an object other than a ball gets too close to the screen, an audio or video alarm may be triggered. Similarly, if a participant gets too close to the screen, the screen will turn red, no points will be granted and/or an audio or visual alarm will be triggered.

In the embodiment shown in FIG. 1, the projection screen 12 has a height 16 of 6 feet and a width 18 of 8 feet. The frame 14 is formed from metal trusses in a classic post and lintel configuration. The projector, control system, and three-dimensional sensor are all mounted, sometimes with a support arm, to the frame. Optionally, a camera for recording participant images may also be mounted on the frame 14. In the embodiment shown in FIG. 1, the projection screen 12 is in a vertical orientation. Optionally, the projection screen can be oriented at an angle or located horizontally on a tabletop or the floor. Similarly, the projection screen can be positioned on a ceiling.

FIG. 2 shows a video kiosk 40 for use with an interactive graphic projection and interface system in accordance with the principles of the invention. Kiosk 40 includes a camera 42, a touchscreen 44 and may optionally include all or some of a payment system 46, a biometric reader 48, a proximity sensor 50, a microphone 52 and a speaker 54. The kiosk 40 is in communication with a control system operating an interactive graphic projection and interface system. In use, an operator interacts with the kiosk 40 to create one or more images incorporated into a graphic image to be displayed on a projector screen. The camera 42 captures one or more still images or short videos of an operator standing in front of the kiosk 40. The operator uses the touchscreen 44 as a user interface to select images for use as part of the graphic display in the interactive graphic projection and interfacing system. The operator may also make short audio recordings and select one or more to be Incorporated into a graphic projection and interface system. Optionally, the kiosk 40 may be used to select from one or more types or categories of graphic images to be displayed on a projector screen. The kiosk 40 may also be utilized to identify specific operators and/or to receive payments.

Many types of interactive graphic games are possible using the system disclosed herein. In one embodiment, the interactive graphic projection and interface system requires no video or audio input from participants. The system provides game options similar to Duck Hunt® where ducks fly across the screen and participants must throw the ball to hit the duck. As with the game Duck Hunt®, when a duck is hit, the graphic image changes to a shocked duck which then falls from the sky. The system also provides a memory game where participants throw the ball to turn over cards. Each game awards participants with points when the correct objects are hit. At the end of each game, participants will see a leaderboard once time expires.

In another embodiment, participants provide one or more graphic images and/or audio recordings which are incorporated into the interactive graphic interface image. Participants take two photos at a the kiosk next to the interactive graphic projection and interfacing system. One photo is of the participant smiling and the other photo is of the participant frowning or making a silly face. When the game starts, the participant must hit as many of his/her faces as he/she can within the allotted time. Each time a face is hit, the smiling face turns into the frowning/silly face and the latter face falls down the screen. At the same time, the participant is awarded points. When the game ends, the leaderboard is shown and the next participant has the opportunity to play. This embodiment is similar to Duck Hunt®, but incorporates images of the participants instead of ducks. This provides a game that is more engaging and enjoyable.

In another embodiment, ball tracking technology using a three-dimensional sensor substantially expands the types of games that may be played. The system may project graphic images such as football players running across the screen. Participants must throw a football into a player's hands. The three-dimensional sensor tracks a football thrown by a participant through the three-dimensional space in front of the screen. Depending on the trajectory of the football and the location that the football impacts the projector screen, the system can decide whether the real football thrown by a real participants was caught by the virtual player.

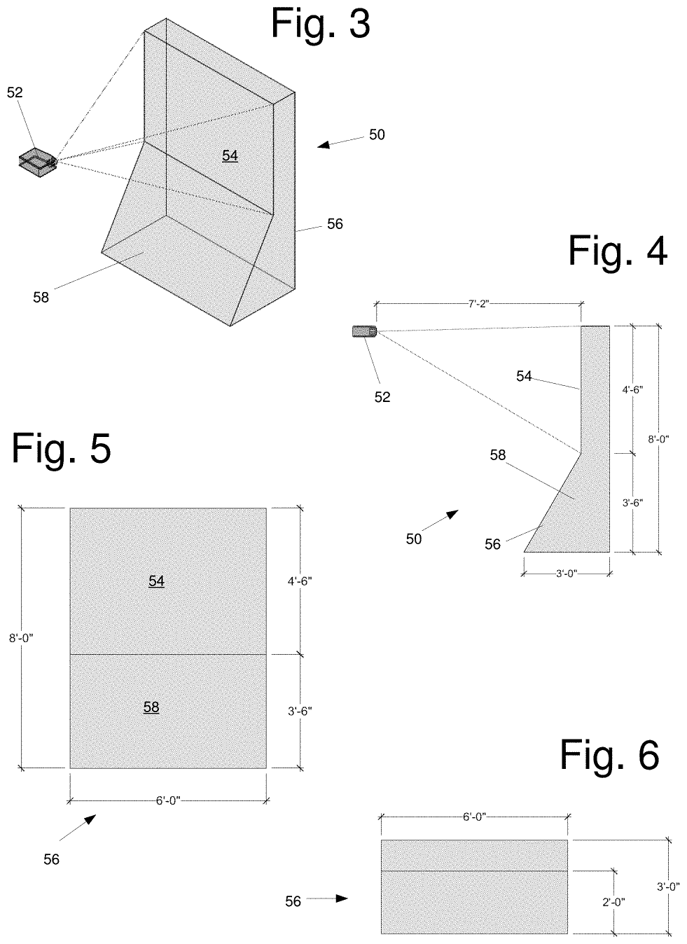

FIGS. 3-6 show an alternative embodiment of an interactive graphic projection game 50 in accordance with the principles of the invention. The system 50 includes a projector 52 and a screen 54 affixed to a frame 56. In this embodiment, the projector 52 is not mounted to the frame 54. The frame 54 includes a base 56 which may be used to store a control system, power supply, camera, microphones, speakers, and one or more three-dimensional sensors. In this embodiment, the projector 52 is just over 7 feet from the projector screen 54. The projector screen has a height of 4′ 6″ and a width of 6 feet.

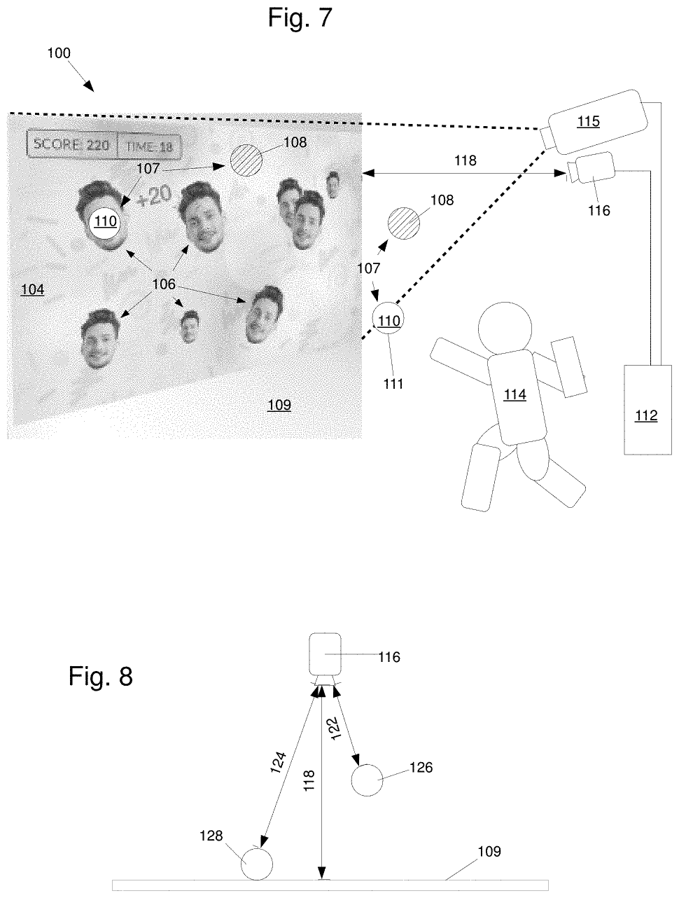

FIGS. 7 and 8 show another alternative embodiment of an interactive graphic projection game 100 in which projectiles 107 are thrown at a background image 104 having a plurality of target images 106 superimposed over the background image 104. Both the background image 104 and the plurality of target images 106 are projected onto the same surface 109. In this embodiment, the projectiles 107 are different colored balls, blue balls 108 and red balls 110. The target images 106 are of a participant's face. A controller 112, in this case a computer, may be programmed to generate the background image 104 and two superimposed target images 106 over the background image 104. A projector 115 is controlled by the controller 112. The target images 106 may be fluid, i.e. moving, or static. In addition, the target images 106 may increase or decrease in size appearing to move further away and closer to the participant 114.

During play, the participant 114 throws a projectile 107, attempting to hit a target image 106. Different colored projectiles may be associated with different participants. In this embodiment, the participant 114 is associated with red balls 110. Red ball 111 has just been thrown by the participant 114. A video camera 116 is positioned a predetermined distance 118 from the background image 104. The projectiles 107 have a predetermined size, in this case measured as a predetermined diameter. Because the size of the projectiles 107 is known, and the distance from the camera 116 to the background image 104 is also known, the controller 112 is able to measure the distance of the ball relative to the camera 116 and to the image by processing the video data from the camera 116. When the video data from the video camera 116 records a projectile 107 having a size, i.e. diameter, corresponding to the distance 118 from the camera 116 to the background image 104, the controller processes that information as the projectile 107 hitting the surface 109. If a projectile 107 hits the surface 109 at the same location where one of the target images 106 is positioned, it registers a hit by the participant 114 corresponding to the color of the projectile 107. In this embodiment, participant 114 has hit one of the target images 106 with a red ball 110. Therefore, the controller will allot a predetermined number of points corresponding to a successful hit. The controller will observe a hit as the image of the projectiles superimposed over a target image 104 when the projectile has the correct size corresponding to a location on the surface 109. Participants may play the game one at a time or simultaneously.

FIG. 8 shows the camera 116 and the surface 109 from a different angle. The ball 126 is a distance 122 from the camera 116, while the ball 128 is a distance 124 from the camera 116. The controller utilizes software sophisticated enough to measure the cross-sectional size, i.e. the diameter, of each ball as well as the incident angle of each ball. This allows the controller to accurately calculate the distance of the ball from both the camera 116 and the surface 109. This in turn allows the controller to accurately determine when a ball has struck the surface 109. Here, all 128 has struck the surface 109 and the camera 116 will observe the ball 128 as having a diameter corresponding to the location of the surface 109. The camera 116 will also take into account the incident angle of the ball 128 relative to the distance 118 which is the shortest distance between the camera 116 and surface 109, thereby being the distance measured along a line perpendicular to the surface 109.

The embodiment shown in FIGS. 7 and 8 is projected onto a plain wall. Optionally, the embodiments of a graphic interactive projection gaming 100 may be combined with a screen and/or frame as described and shown in FIG. 1. It may also be used in conjunction with a kiosk for accepting money, designating numbers of players and selecting target images. Optionally, two cameras may be used to triangulate the location of balls or other projectiles. Optionally, the surface on which the background and target images are projected may be a ceiling or a floor or any other surface.

The video data from the camera 116 will also show whether the ball is on top of a target image 106 when it strikes the surface. If the target images are moving and/or changing sizes over time, the controller may also be programmed to allocate a different number of points to a participant depending on the size and speed of the target image 106. For example, hitting a smaller, faster moving target may cause a participant to earn more points than striking a larger, slower target. Similarly, the controller may vary the size and speed of different target images 106 according to how well a participant is playing. If a participant is scoring a relatively large number of points quickly, the controller may optionally cause the target images 106 to move faster and/or become smaller.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated. Those skilled in the art will appreciate that the conception, upon which this disclosure is based, may readily be utilized as a basis for the designing of other structures, methods and systems for practicing the present invention. It is important, therefore, that the claims be regarded as including such equivalent constructions insofar as they do not depart from the spirit and scope of the present invention.

1. An interactive graphic projection game comprising:
a projector;
a video camera;
a background image projected onto a surface by the projector;
at least one projectile;
a computer in communication with the projector and the video camera, the computer running software that projects at least one target image superimposed over the background image;
wherein the software receives video data from the video camera and registers a hit of the at least one projectile on the at least one target image when the at least one projectile has a predetermined size while the at least one projectile is superimposed over the at least one target image.

2. The interactive graphic projection game of claim 1 wherein the at least one projectile comprises a plurality of projectiles.

3. The interactive graphic projection game of claim 2 wherein the plurality of projectiles comprises a plurality of balls and the predetermined size of the projectiles is a predetermined diameter.

4. The interactive graphic projection game of claim 3 wherein the predetermined diameter of the projectiles is adjusted by the software according to the distance between the video camera and the background image, and the incident angle of the projectiles measured from a direction of shortest distance between the camera and the surface.

5. The interactive graphic projection game of claim 4 wherein the plurality of balls comprises a plurality of balls having different colors, wherein each of the colors corresponds to a predetermined participant, and wherein the hits registered by the software is are categorized and totaled according for each participant.

6. The interactive graphic projection game of claim 5 wherein the surface is a wall.

7. The interactive graphic projection game of claim 5 wherein the surface is a projection screen is mounted on a frame.

8. The interactive graphic projection game of claim 7 wherein the video projector is mounted on a support arm extending from a top of the frame.

9. The interactive graphic projection and interface system of claim 8 wherein a distance between the projection screen and the video projector may be increased or decreased by adjusting the support arm.

10. The interactive graphic projection game of claim 9 wherein the video camera is mounted on the support arm extending from the top of the frame.

11. The interactive graphic projection game of claim 1 further comprising an image recording device in communication with the control system.

12. The interactive graphic projection game of claim 11 wherein the image recording device is incorporated into a kiosk having a touchscreen interface.

13. The interactive graphic projection game of claim 11 wherein the at least one target image is an image of a face of a participant.
